(19) United States
(12) Patent Application Publication
(10) Pub. No.: US 2006/0061248 A1
(43) Pub. Date: Mar. 23, 2006

(54) Uniformity and brightness measurement in OLED displays

(75) Inventors: Ronald S. Cok, Rochester, NY (US); James H. Ford, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/947,655

(22) Filed: Sep. 22, 2004

(51) Int. Cl. H05B 33/00

(52) U.S. Cl. 313/110

(57) ABSTRACT

A system for the detection of brightness uniformity variations in light-emitting elements in an OLED display is described, comprising: a) an OLED display having a plurality of light-emitting elements having perceptible brightness uniformity variations less than a threshold value when driven with a common signal; b) an imager with one or more light-sensitive sensor elements having variable light exposure levels and sensitive to the light emitted by the light-emitting elements, where the sensor elements are not capable of detecting brightness uniformity variations less than the threshold value at a first light exposure level; c) optical elements arranged so that the light-sensitive sensor elements are exposed to the light-emitting elements of the OLED display; and d) a controller programmed to control the OLED display and cause the light-emitting elements to illuminate and the imager to acquire images of the illuminated light-emitting elements in the OLED display at at least the first and a different second light exposure level.

### FIELD OF THE INVENTION

The present invention relates to systems and methods for measuring performance of OLED displays having a plurality of light-emitting elements.

### BACKGROUND OF THE INVENTION

Organic Light Emitting Diodes (OLEDs) have been known for some years and have been recently used in commercial display devices. Such devices employ both active-matrix and passive-matrix control schemes and can employ a plurality of light-emitting elements. The light-emitting elements are typically rectangular and arranged in two-dimensional arrays with a row and a column address for each light-emitting element and having a data value associated with the light-emitting element value. However, such displays suffer from a variety of defects that limit the quality of the displays. In particular, OLED displays suffer from non-uniformities in the light-emitting elements. These non-uniformities can be attributed to both the light-emitting materials in the display and, for active-matrix displays, to variability in the thin-film transistors used to drive the light-emitting elements.

A variety of schemes have been proposed to correct for non-uniformities in displays. These schemes generally rely upon first measuring the light output of the light-emitting elements in a display. U.S. Pat. No. 6,081,073 entitled “Matrix Display with Matched Solid-State Pixels” by Salam granted Jun. 27, 2000 describes a display and a video or display camera or a photo-sensor to detect the light output of the LED display in the presence or absence of ambient light. However, no specification for the resolution of the imaging system or the analysis process is provided.

U.S. Pat. No. 6,414,661 B1 entitled “Method and apparatus for calibrating display devices and automatically compensating for loss in their efficiency over time” by Shen et al issued Jul. 2, 2002 describes a method and associated system that compensates for long-term variations in the light-emitting efficiency of individual organic light emitting diodes in an OLED display device by calculating and predicting the decay in light output efficiency of each pixel based on the accumulated drive current applied to the pixel and derives a correction coefficient that is applied to the next drive current for each pixel. This patent describes the use of a camera to acquire images of a plurality of equal-sized sub-areas. Such a process is time-consuming and requires mechanical fixtures to acquire the plurality of sub-area images.

U.S. Pat. No. 6,473,065 B1 entitled “Methods of improving display uniformity of organic light emitting displays by calibrating individual pixel” by Fan issued Oct. 29, 2002 describes methods of improving the display uniformity of an OLED. In order to improve the display uniformity of an OLED, the display characteristics of all organic-light-emitting-elements are measured, and calibration parameters for each organic-light-emitting-element are obtained from the measured display characteristics of the corresponding organic-light-emitting-element. The technique acquires information about each pixel in turn using a photo-detector. However, this technique is very inefficient and slow in a realistic manufacturing environment.

Digital imaging devices such as digital cameras may be employed for measuring the uniformity variation in an OLED device, as described in copending, commonly assigned U.S. Ser. No. 10/858,260. However, digital cameras typically have a limited exposure range and bit depth within which the imaging devices can capture a scene. In typical devices, the range of light levels that can be captured by the device is automatically set to include both the brightest and dimmest portion of the scene. The imaging devices also have a limited number of bits limiting the number of light levels that can be distinguished by the imaging device. Hence, for scenes that have a wide brightness range, i.e. both very bright and very dim portions, a single image captured by the imaging device cannot distinguish between light levels that are relatively much closer together where the differences in light levels are below a threshold value. For example, a scene containing light levels may have a portion reflecting light at 10,000 cd/m² while another portion may have only 10 cd/m², a range of three decades. An imager with only 256 light levels will measure differences of about 10,000/256 or about 40 cd/m² per light level. Any differences in the scene smaller than the threshold value of 40 cd/m² will not be distinguished. Hence, any low-level variations in light levels beneath the threshold will not be sensed or corrected. However, such non-uniformities may be readily perceptible to a user, particularly at lower light levels.

It is also possible to compensate for a limited capture exposure range by limiting the brightness of the OLED display output. However, applicants have determined that the presence of non-uniformities in an OLED display is at least partially dependent on the brightness of the display. Hence, limiting the brightness of the display may overlook non-uniformities that occur at brighter display levels.

There is a need, therefore, for an improved method of measuring uniformity in an OLED display that overcomes these objections.

### SUMMARY OF THE INVENTION

According to one embodiment of the present invention, a system for the detection of brightness uniformity variations in light-emitting elements in an OLED display is described, comprising: a) an OLED display having a plurality of light-emitting elements having perceptible brightness uniformity variations less than a threshold value when driven with a common signal; b) an imager with one or more light-sensitive sensor elements having variable light exposure levels and sensitive to the light emitted by the light-emitting elements, where the sensor elements are not capable of detecting brightness uniformity variations less than the threshold value at a first light exposure level; c) optical elements arranged so that the light-sensitive sensor elements are exposed to the light-emitting elements of the OLED display; and d) a controller programmed to control the OLED display and cause the light-emitting elements to illuminate and the imager to acquire images of the illuminated light-emitting elements in the OLED display at at least the first and a different second light exposure level.

A method for the detection of brightness uniformity variations in light-emitting elements in an OLED display is also disclosed, comprising: a) providing an OLED display having a plurality of light-emitting elements having perceptible brightness uniformity variations less than a threshold value when driven with a common signal; an imager with one or more light-sensitive sensor elements having variable light exposure levels and sensitive to the light emitted by the light-emitting elements, where the sensor elements are not capable of detecting brightness uniformity variations less than the threshold value at a first light exposure level; and optical elements arranged so that the light-sensitive sensor elements are exposed to the light-emitting elements of the OLED display; b) illuminating the OLED display light-emitting elements; c) acquiring a first image of the OLED display light-emitting elements at the first exposure level; d) acquiring a second image of the OLED display light-emitting elements at a second different exposure level; and e) processing the first and second images of the OLED display light-emitting elements to detect brightness uniformity variations at less than the threshold value to provide a measurement of the brightness of the OLED display light-emitting elements.

### ADVANTAGES

The present invention has the advantage of providing improved efficiency and accuracy in measuring the uniformity of an OLED display.

### BRIEF DESCRIPTION OF THE DRAWINGS

FIG. 1 illustrates a detection system according to one embodiment of the present invention;

FIG. 2 is a flow diagram illustrating the method of one embodiment of the present invention;

FIG. 3 is a flow diagram illustrating an alternative embodiment of the method of the present invention;

FIG. 4 is a graphic illustration of OLED device uniformity variation as found in an embodiment of the present invention; and

FIG. 5 is a flow diagram illustrating a method of processing images in an embodiment of the present invention.

### DETAILED DESCRIPTION OF THE INVENTION

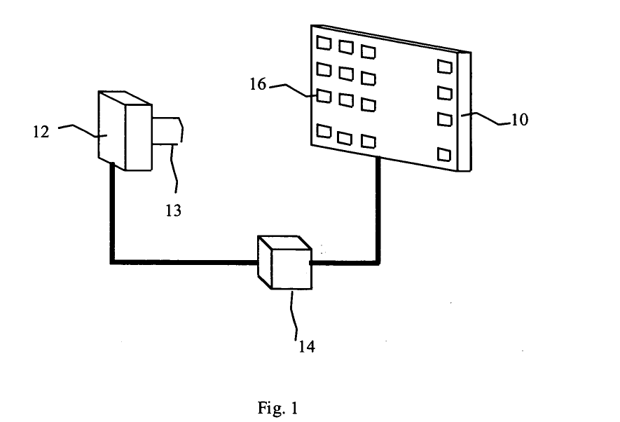

FIG. 1 depicts a system for the detection of brightness uniformity variations in light-emitting elements in an OLED display 10 having a plurality of light-emitting elements 16 having perceptible brightness uniformity variations less than a threshold value when driven with a common signal; an imager 12 with one or more light-sensitive sensor elements having variable light exposure levels and sensitive to the light emitted by the light-emitting elements, where the sensor elements are not capable of detecting brightness uniformity variations less than the threshold value at a first light exposure level; optical elements 13 arranged so that the light-sensitive sensor elements are exposed to the light-emitting elements of the OLED display; and a controller 14 programmed to control the OLED display and cause the light-emitting elements to illuminate and the imager to acquire images of the illuminated light-emitting elements in the OLED display at at least the first and a different second light exposure level.

Optical elements 13 are arranged so that the imager is exposed to the light-emitting elements. Controller 14 controls the OLED display and causes the light-emitting elements to illuminate and the imager to acquire images of the light-emitting elements in the OLED display. The optics 13 may be an integral component of the imager 12 (for example, a camera lens) or may be separate. The imager 12 may be, e.g., a CCD or CMOS sensor, and may be conveniently incorporated in a digital camera.

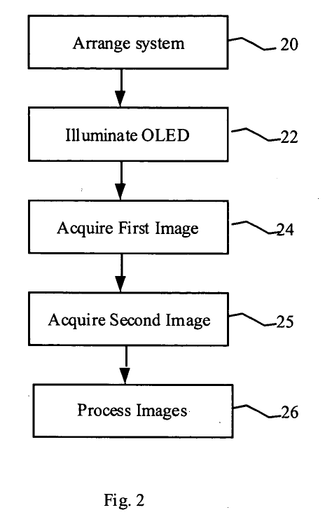

Referring to FIG. 2, a method for the detection of brightness uniformity variations in light-emitting elements in an OLED display comprises the steps of providing 20 a detection system comprising a display, imager, and optical elements as described above; illuminating 22 the OLED display light-emitting elements; acquiring 24 a first image of the OLED display light-emitting elements at the first light exposure level; acquiring 25 a second image of the OLED display light-emitting elements at a second different light exposure level; and processing 26 the first and second images of the OLED display light-emitting elements to detect brightness uniformity variations at less than the threshold value to provide a measurement of the brightness of the OLED display light-emitting elements.

Exposure control within the imager may be controlled by a variety of methods well known in the digital camera art, for example by changing the exposure time or by changing the aperture of a mechanical shutter. Electronic control devices capable of providing digital camera and OLED display control are also well known in the art.

In operation, the OLED display may be illuminated at a desired brightness level, which will be nominally associated with a given code value for driving the OLED display at such desired brightness level. Due to variability in manufacturing processes, however, the actual light emitting elements will vary from the desired brightness level when driven at the given code value. This variation can be quite large, from light-emitting elements that are completely dark to light-emitting elements that are turned on to the maximum brightness of the OLED device. A first exposure level for the imager may be set to effectively capture a digital image of the OLED display so that the brightest OLED light-emitting element is assigned to the largest possible digital image code value and the dimmest OLED light-emitting element is assigned to the smallest digital image code value. OLED light-emitting elements having a brightness between the brightest and dimmest elements will be assigned to code values between the largest and smallest code values. Automatic gain and exposure control devices are well known in the digital camera art and can be employed for this purpose.

In this first exposure, it is likely that relatively minor differences in the brightness of OLED light-emitting elements cannot be distinguished because of the limited number of code values available in the imager. For example, an eight-bit sensor will provide only 256 light level code values and if the number of different perceptible light levels emitted by the OLED light-emitting elements is greater than 256, then some light-emitting elements that differ by only one cd/m² will be assigned to the same sensor value and the differences between the light-emitting elements cannot be distinguished by such eight-bit sensor.

A second exposure level may be set to effectively capture a digital image of the OLED display so that the image is purposefully overexposed, that is a number of the imager elements will be saturated and recorded at the highest sensor level code value, for example at 255 for a 256-light level sensor. The light output from the remainder of the light-emitting elements can then be recorded with the remaining light level code values available to the imaging sensor. This second exposure and image will provide a more sensitive record of the uniformity variation of the unsaturated light emitting elements. Additional exposures, for example underexposures, may be provided at other light levels to provide a sensitive record of the uniformity variation over the entire light-emitting range of the OLED light-emitter.

Correction values for the data taken by the first exposure may be calculated by dividing the code value representing the desired brightness level by the code value of the measured brightness level. Applying this correction to each light-emitting element will create a more uniform output over the OLED display. The more sensitive correction values for the data taken by the second exposure are calculated in a similar way. The code value representing the desired brightness level is divided by the code value of the measured brightness level. However, in the second exposure, the code values representing the brightness levels are different from those of the first exposure, although the correction factor ratios may be similar. In such example, the more sensitive and accurate correction factors are the second group but they are only valid for light-emitting elements having code values less than the maximum measured with the second exposure. In such case, those light-emitting elements having code values measured at the maximum (saturated light-emitting elements in the second exposure) should use the correction factor obtained from the first exposure.

Note that most cameras convert a linear relationship between code value and brightness to a non-linear relationship to more closely match the response of the human eye. Any such conversions must be accommodated in the calculation described above, typically by retransforming the signal to a linear relationship before calculating the correction.

Some digital cameras provide the ability to control the dark current correction. This correction is an offset subtracted from the sensor element signals before digitization. In an alternative embodiment, the camera dark current offset is set so that all signals below a given brightness are set to zero and the remainder are scaled over the available code values provided by the camera, for example 256 levels for 8 bits. This technique provides a more sensitive measure of the signal at a variety of brightness levels.

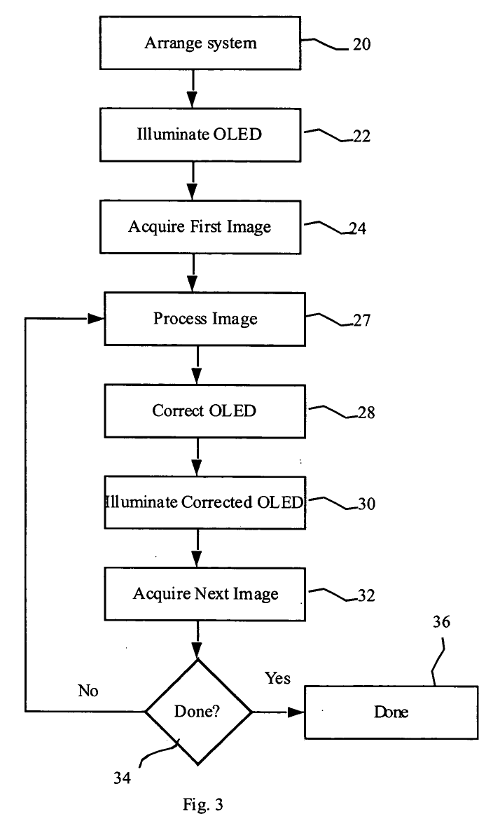

Referring to FIG. 3, the image acquisitions may be performed iteratively and the OLED device corrected iteratively until the device exhibits a desired degree of uniformity at the desired brightness level. As in FIG. 2, the OLED and imager are first provided 20, the OLED illuminated 22 at the desired brightness level, and a first image acquired 24. This first acquisition may be at an exposure that matches the capture range of the image sensor to the brightness range of the OLED device so that both the brightest and dimmest light-emitting elements are within the capture range of the imager. The acquired image is processed 27 to determine a first correction. This correction is calculated as described above. The OLED device is then corrected 28 in the controller. The correction will effectively reduce the brightness variability of the OLED device at the desired brightness level. The process is then repeated. The OLED is illuminated 30 again but with a corrected signal at the desired brightness level. In this case, the brightest light-emitting element will be closer to the desired level and a somewhat improved sensitivity (greater number of code values) will be available for each corrected light-emitting element in a subsequent image acquisition. Another image is acquired 32 at an exposure that matches the capture range of the image sensor when illuminated by the OLED device driven with the corrected signal so that both the brightest and dimmest light-emitting elements are within the capture range of the imager. In this second acquisition, the brightness range between brightest and dimmest light-emitting elements will be smaller so that the imager can distinguish more light levels within the output variability range of the corrected OLED device. The image is tested 34. If the uniformity is acceptable, the process is done 36. If not, the acquired image is processed 27 again to further refine the correction and the process is repeated until an acceptable correction is obtained. After sufficient iterations, all of the light-emitting elements will be measured at a single code value and further iterations are not useful.

The iterative process may be controlled by limiting the number of iterations to a maximum or otherwise pre-defined value, so that the process cannot repeat indefinitely if particular light-emitting elements cannot be corrected, for example if the light-emitting elements' drive circuitry is faulty and fails to respond properly to the code values provided. Alternatively, the process may repeat until the variation is within a particular specification (e.g., until brightness uniformity variations between light-emitting elements are reduced to a predefined value). Specific light-emitting elements may be excluded if they cannot be corrected, particularly if the light-emitting elements are stuck on or off. Automatic exposure control may be used to iteratively adjust the sensitivity of the exposure. However, if stuck light-emitting elements are present, automatic control may not be appropriate if particular light-emitting elements (for example stuck on or stuck off) are present. In this case the stuck light-emitting elements may be excluded and an alternative exposure calculation used that discounts the stuck light-emitting elements.

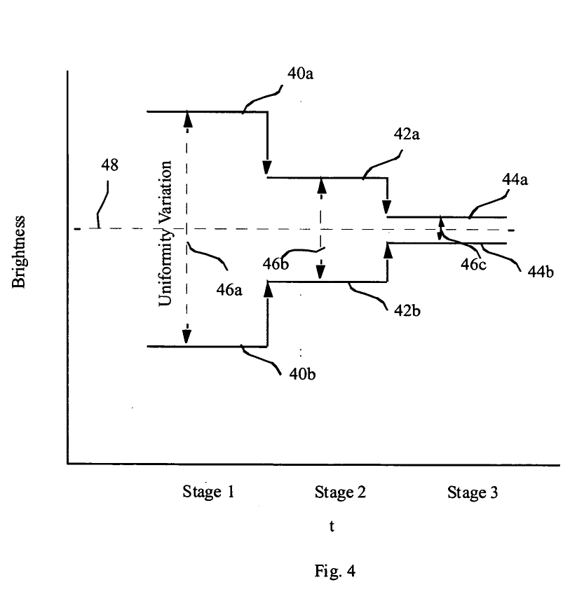

Referring to FIG. 4, the effect of the measurement and correction process is illustrated. Initially, the uniformity variation 46a varies about the desired brightness level 48. At stage 1, the first image is acquired and a relatively wide variation with an upper brightness limit 40a and a lower brightness limit 40b is found. After processing and correction, at stage 2 the range of variation 46b is reduced to an upper limit 42a and lower limit 42b. The process is repeated so that at stage 3 the upper and lower brightness limits 44a and 44b respectively may provide an acceptable uniformity variation. In a color device, this process may be repeated separately for every color. In this case, only the OLED light emitters of a particular color may be illuminated and corrected at a time.

In the present invention, the imager must be arranged so that an image of the illuminated OLED display is acquired by the imager. To accomplish this goal, optical elements 13 (that may be part of the imager or may be a separate optical system) are arranged so that the light-sensitive sensor elements in the imager are exposed to the light-emitting elements distributed across the OLED display. Such an arrangement is readily accomplished with variable focus lenses, zoom lenses, or fixtures that arrange the imager and OLED display in an appropriate orientation and arrangement. Preferably, the orientation of the imager is matched to the orientation of the OLED display and the optical axis of the camera is orthogonal to, and centered on, the OLED display. The imager may be precisely focused on the surface of the display. Alternatively, Applicants have determined through experimentation that more consistent and accurate measurements with respect to actual uniformity performance between light-emitting elements may be obtained wherein optical elements are used to form a slightly defocused image of the light-emitting elements of the OLED display on the imager. Such defocusing may be particularly helpful when employing light-emitting elements having an irregular but predominantly rectangular shape (which may be used as noted above to make room for electronic components or wiring connections), or for light-emitting elements otherwise having non-uniformities within the light emitting area of a single element. Techniques for optically arranging the imager and OLED display are very well known in the art. Additional methods and systems for extracting brightness information from an image of an OLED device that may be used in the present invention may be found in copending, commonly assigned U.S. Ser. No. 10/858,260, the disclosure of which is incorporated by reference herein.

Once an image has been acquired the controller 14 or an external computer can process the image to extract the luminance of each light-emitting element in the OLED display. Techniques for such image processing are known in the art and can include, for example, thresholding, morphological processing, and averaging. As one example of an image processing procedure useful with the present invention, a histogram of an acquired OLED display light-emitting element image may be formed and a threshold value chosen between the two highest histogram values. Contiguous areas in the image with a value above the threshold value may be segmented to form light-emitting element groups. A variety of statistical operations may then be derived for each light-emitting element group.

In any real manufacturing system, there are variables in the manufacturing process that lead to reduced yields. In the method of the present invention, additional steps may be employed to improve the robustness of the process. Noise sources can include ambient radiation incident on the OLED display, misalignment of the OLED display and imager, imager variability, thermal variability, and OLED variability. These noise factors can be controlled with suitable process enhancements.

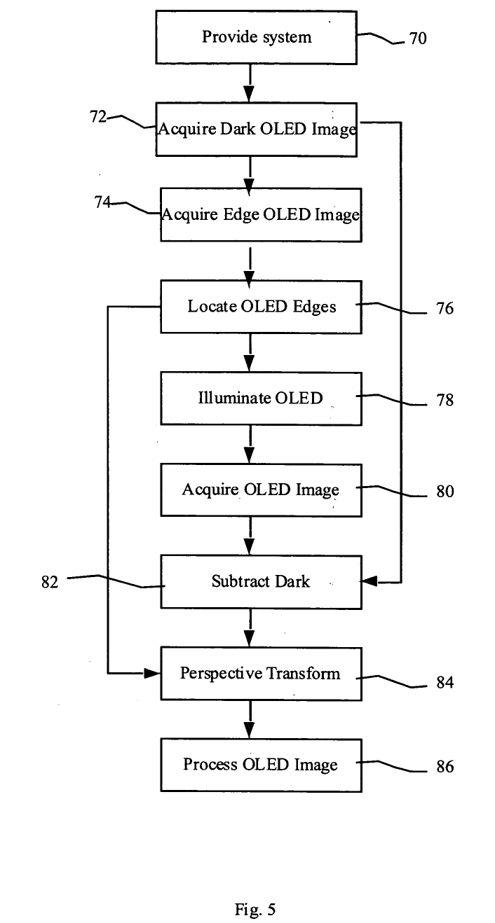

Referring to FIG. 5, an enhanced process according to another embodiment of the present invention includes providing 70 the detection system described above. The controller then turns off all OLED light-emitting elements and acquires 72 an image of the OLED (a dark image). Subsequently, the controller turns on OLED edge light-emitting elements (for example the top and bottom row and left-most and right-most columns or the four corners) and acquires 74 a second image of the OLED (edge image). Once the edge image is acquired, the edges of the OLED can be located 76 by image processing. If the edges are not parallel, the OLED display may be misaligned with respect to the imager. In this case, a perspective transform may be performed to correct the misalignment (as described, for example in Digital Image Processing 2^{nd} edition by William K. Pratt, John Wiley and Sons, 1991, p. 434-441). The OLED display is illuminated 78 with a flat field at a given luminance level for all the light-emitting elements in a group to be measured. The imager then acquires 80 the flat-field OLED image. The dark image is then subtracted 82 from the flat-field OLED image to correct for any ambient illumination present and any imager and thermal variability in the imager. The OLED image is then corrected for any misalignment by performing a perspective transform 84. The OLED image is then processed to calculate the OLED light-emitting element characteristics.

It is known that non-uniformity in an OLED display may be dependent on the luminance of the display. According to another embodiment of the present invention, the method may be repeated at a variety of luminance levels to provide a record of display brightness and uniformity at each luminance level.

The invention has been described in detail with particular reference to certain preferred embodiments thereof, but it will be understood that variations and modifications can be effected within the spirit and scope of the invention.

### PARTS LIST

10 OLED display
12 imager
13 optics
14 controller
16 light-emitting elements
20 provide system step
22 illuminate OLED step
24 acquire first image step
25 acquire second image step
26 process images step
27 process image step
28 correct OLED step
30 illuminate corrected OLED step
32 acquire next image step
34 decision step
36 done step
40a upper brightness uniformity limit
40b lower brightness uniformity limit
42a upper brightness uniformity limit
42b lower brightness uniformity limit
44a upper brightness uniformity limit
44b lower brightness uniformity limit
46a-c brightness uniformity variations
48 desired brightness
70 provide system step
72 acquire dark image step
74 acquire edge image step
76 locate OLED edges step
78 illuminate OLED step
80 acquire OLED image step
82 subtract dark image step
84 perspective transform step
86 process OLED image step

1. A system for the detection of brightness uniformity variations in light-emitting elements in an OLED display, comprising:
a) an OLED display having a plurality of light-emitting elements having perceptible brightness uniformity variations less than a threshold value when driven with a common signal;
b) an imager with one or more light-sensitive sensor elements having variable light exposure levels and sensitive to the light emitted by the light-emitting elements, where the sensor elements are not capable of detecting brightness uniformity variations less than the threshold value at a first light exposure level;
c) optical elements arranged so that the light-sensitive sensor elements are exposed to the light-emitting elements of the OLED display; and
d) a controller programmed to control the OLED display and cause the light-emitting elements to illuminate and the imager to acquire images of the illuminated light-emitting elements in the OLED display at at least the first and a different second light exposure level.

2. The system of claim 1 wherein the imager is incorporated into a digital camera.

3. The system of claim 1 wherein the optical elements form a defocused image of the light-emitting elements of the OLED display on the imager.

4. The system of claim 1 wherein the optical elements form a focused image of the light-emitting elements of the OLED display on the imager.

5. A method for the detection of brightness uniformity variations in light-emitting elements in an OLED display, comprising:
a) providing an OLED display having a plurality of light-emitting elements having perceptible brightness uniformity variations less than a threshold value when driven with a common signal; an imager with one or more light-sensitive sensor elements having variable light exposure levels and sensitive to the light emitted by the light-emitting elements, where the sensor elements are not capable of detecting brightness uniformity variations less than the threshold value at a first light exposure level; and optical elements arranged so that the light-sensitive sensor elements are exposed to the light-emitting elements of the OLED display;
b) illuminating the OLED display light-emitting elements;
c) acquiring a first image of the OLED display light-emitting elements at the first exposure level;
d) acquiring a second image of the OLED display light-emitting elements at a second different exposure level; and
e) processing the first and second images of the OLED display light-emitting elements to detect brightness uniformity variations at less than the threshold value to provide a measurement of the brightness of the OLED display light-emitting elements.

6. The method of claim 5 further comprising illuminating the OLED display light-emitting elements at a variety of illumination levels and detecting brightness uniformity variations at the variety of illumination levels.

7. The method of claim 5 wherein the light-emitting OLED elements include differently colored elements and wherein light-emitting OLED elements of a common color are illuminated and brightness uniformity variations in light-emitting elements of a common color are detected.

8. The method of claim 5 further comprising the step of compensating the OLED display light-emitting elements for any non-uniformity found at the first exposure level before acquiring a second image of the OLED display light-emitting elements at a second exposure level.

9. The method of claim 8 wherein the first exposure level is selected to be responsive to a greater brightness range than the second exposure level.

10. The method of claim 9 further comprising the steps of iteratively acquiring images at exposure levels selected to be responsive to increasingly smaller brightness ranges and iteratively compensating the OLED display light emitters before acquiring a subsequent image.

11. The method of claim 10 wherein the number of iterations performed is pre-defined.

12. The method of claim 10 wherein the iterations are repeated until brightness uniformity variations between light-emitting elements are reduced to a predefined value.
